(19) United States
(12) Patent Application Publication
(10) Pub. No.: US 2006/0267868 A1
(43) Pub. Date: Nov. 30, 2006

(54) Plasma display panel

(76) Inventors: Hyun Kim, Suwon-si (KR); Seok-Gyun Woo, Suwon-si (KR); Kyoung-Doo Kang, Suwon-si (KR)

Correspondence Address: CHRISTIE, PARKER & HALE, LLP, PO BOX 7068, PASADENA, CA, 91109-7068, US

(21) Appl. No.: 11/432,801

(22) Filed: May 11, 2006

(30) Foreign Application Priority Data
May 25, 2005 (KR) 10-2005-0044039

(51) Int. Cl. G09G 3/28

(52) U.S. Cl. 345/60

(57) ABSTRACT

A plasma display panel includes first and second substrates located opposite to each other. Barrier ribs partition a space between the substrates into a plurality of discharge cells. Address electrodes are formed with a first portion extending along a first direction on the first substrate and a plurality of protruding portions projecting from the first portion into the discharge cells in a direction substantially perpendicular to the first substrate. Pairs of display electrodes extend in a second direction crossing the first direction. The discharge cells may be polygonal or cylindrical and the display electrodes may form rings around a corresponding discharge cell between the substrates. The protruding portions are bars projecting into the discharge cells such that a gap between two display electrodes of a discharge cell is larger than a gap between the display electrodes and the protruding portion of the address electrodes.

### CROSS-REFERENCE TO RELATED APPLICATION

This application claims priority to and the benefit of Korean Patent Application No. 10-2005-0044039 filed in the Korean Intellectual Property Office on May 25, 2005, the entire content of which is incorporated herein by reference.

### BACKGROUND OF THE INVENTION

(a) Field of the Invention

The present invention relates to a plasma display panel (PDP). More particularly, the present invention relates to a PDP which can utilize a high efficiency discharge mode of a positive column while increasing a discharge area and operating at a low address voltage.

(b) Description of the Related Art

In general, a PDP is used in a display device to implement display of images by exciting phosphors with vacuum ultraviolet (VUV) rays generated by gas discharge within a discharge cell. The PDP can be classified into a DC type and an AC type depending on the applied driving voltage waveform and the structure of a discharge cell. An AC PDP having a three-electrode surface discharge structure has been widely used.

The AC PDP includes a front substrate and a rear substrate, which are opposite to each other. Barrier ribs are formed between the front substrate and the rear substrate. The barrier ribs partition the space between the front and rear substrates into a plurality of discharge cells. Address electrodes are formed on the rear substrate and display electrodes are formed on the front substrate, corresponding to each of the discharge cells. Depending on function, the display electrode may be a scan electrode or a sustain electrode. In addition, each of the address electrodes and the display electrodes is covered with a dielectric layer. A phosphor layer is formed on the inside of each discharge cell. A discharge gap of approximately 60 μm to 120 μm in size, also referred to as a “short discharge gap,” is formed between the scan electrode and the sustain electrode located within one discharge cell.

The AC PDP has limitations. For example, panel efficiency, which is the ratio of brightness to power consumption, can be increased only to a limited extent. Furthermore, because a display electrode, a dielectric material, a protective layer, and other similar layers are sequentially formed on the front substrate, transmittance of visible light is limited. In addition, discharge is generated in the upper part of discharge space, i.e., a peripheral region of the front substrate through which visible light passes, and diffused into the lower part of the discharge space where the phosphor layers are typically located. This process decreases luminous efficiency.

Although much research has been conducted in order to solve the above problems, the results of the research have been restricted by the discharge cell structure that includes the aforementioned short discharge gap. Therefore, recently, there has been active research regarding a new discharge cell structure and accordingly a new driving method. Included in this research is a technology using positive column discharge characteristics.

According to the new technology, a discharge gap of 400 μm or greater in size, also referred to as a “long discharge gap,” is formed between the scan electrode and the sustain electrode located within one discharge cell. A positive column discharge generated in the long discharge gap is used to drive the PDP. The AC PDP using the positive column discharge characteristics, however, has its own set of problems because the discharge firing voltage and the sustain voltage are high in comparison with the voltages involved in a short discharge gap.

### SUMMARY OF THE INVENTION

The present invention provides a PDP utilizing the high efficiency discharge mode of a positive column region while improving luminous efficiency through maximization of a discharge surface and a discharge space.

An exemplary PDP according to an embodiment of the present invention includes a first substrate and a second substrate located opposite to each other, barrier ribs that are located between the first substrate and the second substrate and partition a space between the substrates into a plurality of discharge cells, address electrodes, each having a first portion extending along a first direction on the first substrate and a protruding portion projecting from the first portion toward the second substrate in a direction perpendicular to the first substrate, and display electrodes extending in a second direction crossing the first direction between the first substrate and the second substrate.

The display electrodes may be formed to surround the protruding portion and be spaced apart from the protruding portion, and they may form a closed loop around the protruding portion. The closed loop may be circular or polygonal.

The display electrodes may include a first electrode and a second electrode, which are spaced apart from each other in a direction perpendicular to the first substrate. A gap between the first electrode and the second electrode may be longer than a gap between the protruding portion and the first electrode, or a gap between the protruding portion and the second electrode.

The protruding portion may have a bar shape. A cross section of the protruding portion may be circular or polygonal.

The protruding portion may correspond to each of the discharge cells. The height of the protruding portion may be the same as a distance between the first substrate and the second substrate located opposite to each other.

The display electrodes may be formed of substantially the same material as the address electrodes, and may be formed from a conductive metal material. A dielectric layer may be further formed on an outer surface of the protruding portion, and a protective layer may be further formed on an outer surface of the dielectric layer.

A method for driving a plasma display panel is also presented. The plasma display panel has a front substrate and a rear substrate. Discharge cells are formed within a space between the front substrate and the rear substrate. First and second display electrodes corresponding to each discharge cell are formed in pairs surrounding the discharge cell. The first and second display electrodes within a pair are located at a first gap from each other. Address electrodes including portions protruding inside each of the discharge cells are formed on the first substrate. The portions have a second gap from the first and second display electrodes. The first gap is measured along a direction substantially parallel to walls surrounding the discharge cells and substantially perpendicular to the rear substrate. The second gap is measured along a direction substantially parallel to the rear substrate. The method includes applying a first voltage having a first pulse to one of the first and second display electrodes; applying a second voltage having a second pulse to the other one of the first and second display electrodes, the second pulse being equal to the first pulse in amplitude and duration but being delayed with respect to the first pulse; and applying a third voltage having a third pulse to the address electrodes, the third pulse having an amplitude and a duration both smaller than the second pulse, the third pulse repeating to coincide with each occurrence of the first pulse and each occurrence of the second pulse. A voltage difference between the address electrodes and one of the first and second display electrodes across the second gap triggers a discharge in the discharge cells, and a voltage difference between the first and second display electrodes across the first gap sustains the discharge in the discharge cells.

### BRIEF DESCRIPTION OF THE DRAWINGS

FIG. 1 is a partial exploded perspective view of a PDP according to a first exemplary embodiment of the present invention.

FIG. 2A is a partial sectional view of one discharge space of the PDP of FIG. 1.

FIG. 2B is a partial perspective view of display electrodes of the PDP of FIG. 1.

FIG. 3 is a sustain waveform diagram according to a first exemplary embodiment of the present invention for illustrating a driving process of a PDP.

FIG. 4 is a schematic diagram showing a discharge formation process within a discharge cell in a PDP according to a first exemplary embodiment of the present invention.

FIG. 5 is a schematic plan view of a single discharge cell in a PDP according to a second exemplary embodiment of the present invention.

### DETAILED DESCRIPTION

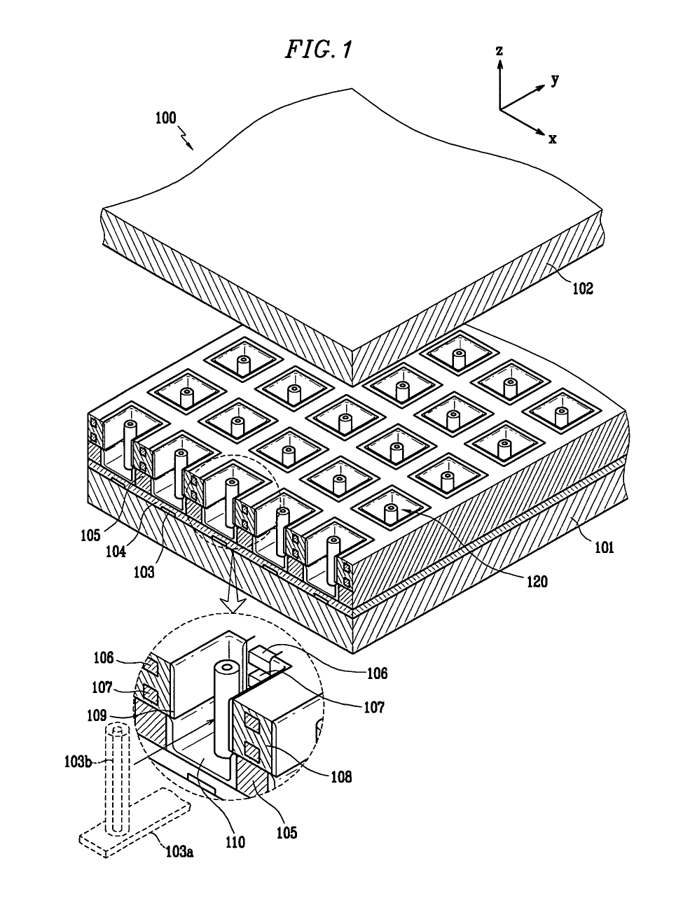

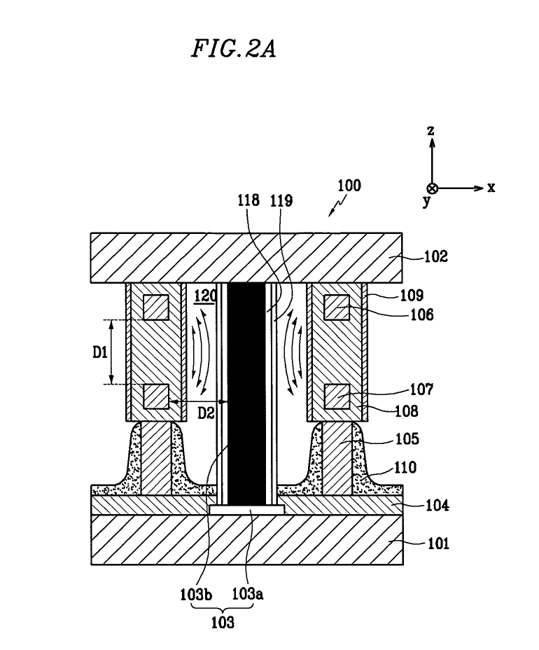

Referring to FIGS. 1, 2A, and 2B, a PDP 100 according to an exemplary embodiment of the present invention includes a first substrate 101, also referred to as a “rear substrate,” and a second substrate 102, also referred to as a “front substrate,” which are located opposite to each other with a distance therebetween. Barrier ribs 105, which partition the space between the rear and front substrates 101, 102, into a plurality of discharge cells 120, are located between the front substrate 102 and the rear substrate 101 in a predetermined pattern. The plurality of discharge cells 120 form independent discharge spaces by means of the barrier ribs 105. In the first exemplary embodiment shown in FIG. 1, the cross-sectional area of each of the discharge cells 120 is rectangular. In alternative embodiments, the cross-sectional area of the discharge cells 120 can be polygonal, circular, or elliptical.

Display electrodes are formed in a closed-loop or ring form to surround the discharge space within each of the discharge cells 120. The loop may have a cross-sectional area that is not circular. The closed loops or rings form one row of display electrodes extending in a second direction (an x-axis direction in the drawings) crossing a first direction (a y-axis direction in the drawings) along which address electrodes 103 extends. Each of the display electrodes includes a first electrode 106 and a second electrode 107. The first electrodes 106 of the discharge cells 120 extending along the second direction are coupled together also along the second direction (the x direction). Similarly, the first electrodes 107 of the discharge cells 120 are coupled together along the second direction (the x direction). In more detail, the first electrodes 106 and the second electrodes 107 include first portions 106a, 107a and second portions 106b, 107b. The first portions 106a, 107a extend along the second direction, and the second portions 106b, 107b extend in a first direction crossing the second direction (y direction). The first electrode 106 and the second electrode 107 corresponding to a discharge cell 120 are spaced apart from each other in a direction (a z-axis direction in the drawings) that is substantially perpendicular to the rear substrate 101. A dielectric layer 108 is formed on an outer surface of the pair of first electrode 106 and second electrode 107. The dielectric layer 108 can be formed to have the same pattern as the barrier ribs 105. Furthermore, the first electrode 106 and the second electrode 107 forming a pair are insulated from each other within the dielectric layer 108. A protective layer 109 is further formed on surfaces of the dielectric layer 108 which are exposed to the discharge space within the discharge cells 120. The protective layer 109 may be formed from magnesium oxide (MgO).

In the present exemplary embodiment, the first electrode 106 and the second electrode 107 constituting the display electrode are formed as closed loops. In addition, as shown in FIG. 1, the cross sectional shape of the closed loop in the xy plane can be rectangular, which is substantially identical to the cross sectional shape of the discharge cells 120. However, the cross sectional shape of the display electrode is not limited to a rectangular shape, and can be polygonal, circular, elliptical, or the like.

The structure of the first electrode 106 and the second electrode 107 surrounding the discharge space as described above can further improve the aperture ratio and transmittance of a PDP. In more detail, in the PDP of the related art, an indium tin oxide (ITO) electrode, a bus electrode, and a dielectric layer covering the ITO electrode and the bus electrode are located on the front substrate of the PDP. In the PDP according to the present exemplary embodiment, however, the ITO electrode, the bus electrode, and the dielectric layer covering these electrodes are not located on the front substrate 102. Therefore, the aperture ratio of the front substrate 102 can be significantly improved. Furthermore, transmittance of visible light can be improved and luminous efficiency can be maximized.

In the present exemplary embodiment, the address electrode 103 includes a first portion 103a and a protruding portion 103b. The first portion 103a extends in the first direction (the y-axis direction in FIG. 1) on the rear substrate 101. The protruding portion 103b projects from the first portion 103a toward the front substrate 102 in a direction substantially perpendicular to the rear substrate 101. The first portion 103a functions to apply a voltage for selecting a discharge cell 120 that is selected to emit light. In addition, the protruding portion 103b functions to generate an address discharge between the display electrodes 106, 107.

The protruding portion 103b of the address electrode 103, which projects into the discharge space within a discharge cell 120, is surrounded by the closed loop of the display electrodes 106, 107. That is, the display electrodes 106, 107 form a closed loop, or ring, around the protruding portion 103b while being isolated from the protruding portion 103b. A first gap D1 between the first electrode 106 and the second electrode 107, together constituting the display electrode, is set to be greater than a second gap D2 between the protruding portion 103b and the first electrode 106 or the second electrode 107. That is, the gap D1 between electrodes that take part in a sustain discharge 106, 107 is set to be greater than the gap D2 between electrodes that take part in an address discharge 103, 106, 107. Due to this spacing, the address discharge can be generated at a lower voltage. At the same time, the sustain discharge can be generated with the long discharge gap which can generate a positive column.

In FIG. 1, the protruding portion 103b of the address electrode 103 has a bar shape having a circular cross section. However, the protruding portion 103b can have a polygonal or oval cross section. The protruding portion 103b of the address electrode 103 is located corresponding to each of the discharge cells 120. The first portion 103a and the protruding portions 103b can be formed using a metal having good conductivity, such as silver (Ag).

An address electrode dielectric layer 118, which is formed of substantially the same material as that of the dielectric layer 108 formed on the outer surface of the display electrodes 106, 107, is formed on an outer surface of the protruding portion 103b. An address electrode protective layer 119 formed from MgO can be further formed on the dielectric layer 118. It is thus possible to prevent the electrodes 103, 106, 107 from being degraded due to a plasma discharge between the electrodes.

Phosphor layers 110 are formed on a rear substrate dielectric layer 104 covering the first portion 103a of the address electrode 103 and along the lateral sides of the barrier ribs 105. The phosphor layers 110 are excited with UV rays generated by a discharge gas to emit visible light. The phosphor layers 110 can be formed at any portion within the discharge cells 120. For example, in the present exemplary embodiment shown in FIG. 2A, the phosphor layers 110 can be formed at the bottom of the discharge cells 120 on the rear substrate 101 side and on the sides of the barrier ribs 105. However, the present invention is not limited to the embodiment shown, as the phosphor layers 110 can be formed only at the front substrate 102, or can be formed at both of the front substrate 102 and the rear substrate 101.

The inside of the discharge cells 120 is filled with a discharge gas such as a mixture of neon and xenon (Ne—Xe). Typically, the higher the partial pressure of the Xe gas, the better the luminous efficiency. However, the higher the partial pressure of the Xe gas, the higher the discharge firing voltage. In the case of the present exemplary embodiment, the discharge surface is increased and discharge area can be expanded. The discharge area refers to a region of the discharge space where discharge occurs. Therefore, the amount of plasma generated is increased. As a result, although the partial pressure of the Xe gas is increased, a low driving voltage is still possible.

A discharge formation process during a sustain period between the address electrode 103 and the first electrode 106 and between the address electrode 103 and the second electrode 107, which are constructed according to the first exemplary embodiment, will be described blow.

Referring first to FIG. 2A, the discharge between the address electrode 103 and the display electrodes 106, 107 is initiated between the first electrode 106 and the protruding portion 103b opposite to the first electrode 106 and between the second electrode 107 and the protruding portion 103b opposite to the second electrode 107. The gaps between the address electrode 103 and either of the first or second electrodes 106, 107 correspond to the second gap D2 which is a short gap. The discharge initiated as described above is diffused along the protruding portion 103b of the address electrode 103. A main discharge by a positive column discharge process is finally generated between the first electrode 106 and the second electrode 107 across the first gap D1.

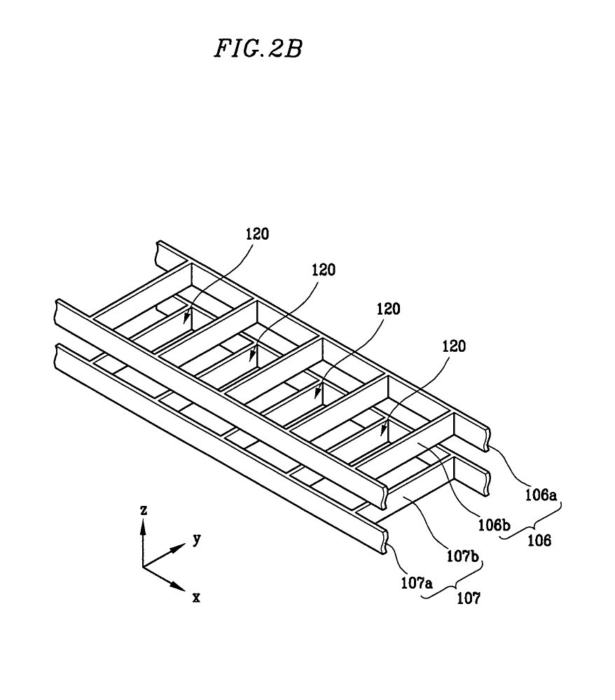

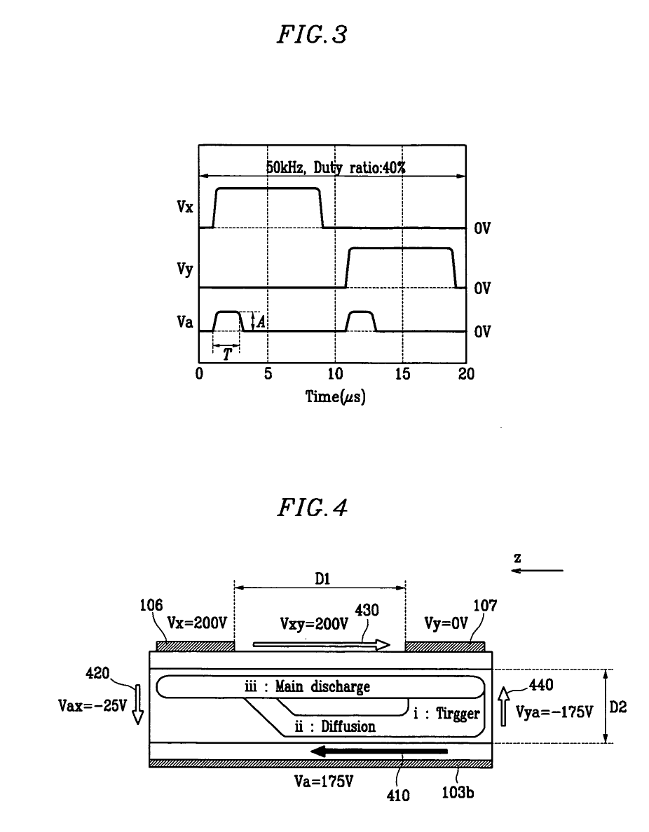

FIGS. 3 and 4 show the positive column discharge formation process.

In FIG. 3, “Vx” indicates a voltage applied to the first electrode 106. “Vy indicates a voltage applied to the second electrode 107. “Va” indicates a voltage applied to the protruding portion 103b of the address electrode 103. In FIG. 4, a black arrow 410 indicates a direction where a discharge is in progress and white arrows 420, 420, 440 indicate directions of electric fields formed by a voltage difference. Voltages shown in FIG. 4 are exemplary voltages used to initiate a discharge. A sustain voltage Vxy in an actual sustain discharge can be approximately 160V and an address pulse voltage Va can be approximately 80V.

Referring to FIG. 3, a sustain waveform for sustaining a discharge is applied between the first electrode 106 and the second electrode 107 of the display electrode at a frequency of 50 kHz and a duty ratio of 40%. In addition, a width T and an amplitude A of a pulse waveform applied to the protruding portion 103b of the address electrode can be changed in various manners. In the present exemplary embodiment, a voltage pulse is applied to the protruding portion 103b of the address electrode in synchronization with sustain voltage pulses of the first electrode 106 and the second electrode 107. As the voltage pulses Vx, Vy applied to the first electrode 106 and the second electrode 107 are synchronized with the voltage pulse Va applied to the protruding portion 103b of the address electrode, a negative potential is sequentially applied to the first electrode 106 and the second electrode 107. Therefore, the discharge firing voltage and the sustain voltage can be lowered.

In more detail, in FIG. 4, because an inter-electrode gap D1 of the first electrode 106 and the second electrode 107 is great, an initial discharge (i: trigger) begins between the first electrode 106 and the protruding portion 103b of the address electrode or between the second electrode 107 and the protruding portion 103b of the address electrode that are separated by the short discharge gap D2. This initial discharge is initiated and assisted by the address voltage applied to the address electrode 103 and a sustain voltage applied between the first electrode 106 and the second electrode 107. The initial discharge is diffused (ii: diffusion) along the z direction upwardly or downwardly within the discharge cell along the height of the protruding portion 103b. A main discharge (iii: main discharge) is generated between the first electrode 106 and the second electrode 107 separated by the long discharge gap D1. In more detail, a discharge is triggered (i: trigger) between the second electrode 107 and the protruding portion 103b of the address electrode by means of an electric field induced by Vxy and Vya. The discharge is diffused (ii: diffusion) along the protruding portion 103b of the address electrode by means of electrons provided to the dielectric layer and the phosphor layer. The discharge is directed to the first electrode 106 to generate a main discharge (iii: main discharge).

In the present exemplary embodiment, the first electrode 106 and the second electrode 107 are formed along the sides of the discharge space in a ring or loop form around the discharge cell 120. The first and second electrodes 106, 107 are, therefore, adjacent along the entire perimeter of the discharge cell 120. Therefore, a possibility that a discharge can be generated is significantly increased in comparison with the related art in which the display electrodes are formed only on a top surface of the discharge cell. In addition, because the voltage difference between the first electrode 106 and the second electrode 107 is maintained for a predetermined time, a discharge near the display electrodes 106, 107 can be diffused into the entire discharge space. A discharge in the present exemplary embodiment is generated in ring form all around the internal perimeter of the discharge cell along the side or wall of the discharge space and is then diffused into a central region of the discharge space. Therefore, in the discharge of the present exemplary embodiment, diffusion range and volume of a region where discharge occurs are significantly increased in comparison with discharge in the related art. As a result, the amount of visible light generated is increased and spatial charges can be utilized because plasma is concentrated in the central region of the discharge space. Therefore, driving by a low voltage is made possible and luminous efficiency is enhanced.

Hereinafter, a variety of alternative exemplary embodiments of the present invention will be described. A PDP according to each exemplary embodiment has the same or similar construction and operation as the first exemplary embodiment. Detailed description of the similar aspects will be omitted.

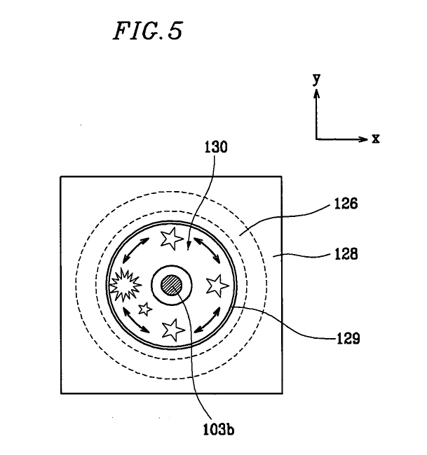

FIG. 5 is a schematic plan view of a single discharge cell of a PDP according to a second exemplary embodiment of the present invention. The PDP according to the second exemplary embodiment has the same or similar construction and operation as the first exemplary embodiment. Detailed description of similar parts and processes is omitted.

In the PDP according to the second exemplary embodiment, a display electrode 126 is substantially circular in cross section. Cross section of a discharge cell 130 is also substantially circular and accordingly, a substantially cylindrical discharge space is formed.

Reference numeral 128 indicates a dielectric layer covering the display electrode 126. Reference numeral 129 indicates a protective layer covering the outer surface of the dielectric layer 128. The protective layer 129 may be formed from MgO.

In the PDP according to the second exemplary embodiment of the present invention a front substrate through which visible light passes is not obscured by other elements. For this reason, the aperture ratio can be significantly increased. Also, transmittance can be increased from 60% or less in the related art up to about 90% or higher.

Furthermore, because a main surface discharge can be generated along all sides forming the discharge space, a discharge surface can be expanded about 4 times or greater in comparison with the related art.

A discharge is generated along the sides forming the discharge space and is then diffused into a central region of the discharge space as schematically shown by the various sized star and arrows. Therefore, the entire discharge space can be efficiently used. The volume of plasma produced by the discharge can be significantly increased and more UV rays can be radiated.

In addition, as the address electrode is employed to initiate the discharge, a discharge across a long discharge gap can be easily generated between the display electrodes even with a low discharge firing voltage and sustain voltage. Further, because a positive column region is formed by the discharge across the long discharge gap, a high-efficiency discharge mode can be utilized when the PDP is driven.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims and their equivalents.

What is claimed is:

1. A plasma display panel comprising:
a first substrate and a second substrate located opposite to each other providing a space in between;
barrier ribs located between the first substrate and the second substrate partitioning the space in between into a plurality of discharge cells;
address electrodes, each having a first portion extending along a first direction on the first substrate and a protruding portion projecting from the first portion in a corresponding discharge cell toward the second substrate in a direction substantially perpendicular to the first substrate; and
display electrodes extending in a second direction crossing the first direction between the first substrate and the second substrate, the display electrodes being arranged in pairs corresponding to a row of the discharge cells along the second direction and surrounding each of the discharge cells in the row.

2. The plasma display panel of claim 1, wherein the display electrodes surround the protruding portion and are spaced apart from the protruding portion.

3. The plasma display panel of claim 2, wherein the display electrodes form a closed loop around the protruding portion.

4. The plasma display panel of claim 3, wherein the closed loop is polygonal.

5. The plasma display panel of claim 3, wherein the closed loop is circular.

6. The plasma display panel of claim 1,
wherein the pairs of display electrodes include a first electrode and a second electrode spaced apart from each other in a direction substantially perpendicular to the first substrate, and
wherein a gap between the first electrode and the second electrode is longer than a gap between the protruding portion and the first electrode or a gap between the protruding portion and the second electrode.

7. The plasma display panel of claim 1, wherein the protruding portion is bar shaped.

8. The plasma display panel of claim 7, wherein a cross section of the protruding portion is circular.

9. The plasma display panel of claim 7, wherein a cross section of the protruding portion is polygonal.

10. The plasma display panel of claim 1, further comprising a plurality of protruding portions corresponding to a first portion, wherein each of the plurality of protruding portions correspond to each of the discharge cells.

11. The plasma display panel of claim 1, wherein height of the protruding portion is equal to a distance between the first substrate and the second substrate.

12. The plasma display panel of claim 1, wherein the display electrodes are formed of substantially the same material as the address electrodes.

13. The plasma display panel of claim 1, wherein the display electrodes are formed of a conductive metal material.

14. The plasma display panel of claim 1, further comprising a dielectric layer formed on an outer surface of the protruding portion.

15. The plasma display panel of claim 14, further comprising a protective layer formed on an outer surface of the dielectric layer.

16. A plasma display panel comprising:
a first substrate and a second substrate located opposite to each other providing a space in between, the space being partitioned into discharge cells;
address electrodes, each having a first portion extending along a first direction on the first substrate and protruding portions projecting from the first portion toward the second substrate within each of the discharge cells located along the first portion; and
display electrodes located between the first substrate and the second substrate within walls of the discharge cells,
wherein the display electrodes include first electrodes and second electrodes, each of the first electrodes and each of the second electrodes surrounding a corresponding one of the discharge cells,
wherein the first electrodes are coupled together along a second direction crossing the first direction and the second electrodes are coupled together along the second direction,
wherein a first electrode and a second electrode corresponding to each discharge cell form a pair and are stacked one on top of the other providing a first gap in between the first electrode and the second electrode,
wherein the first electrodes and the protruding portions corresponding to each one of the discharge cells have a second gap in between,
wherein the second electrodes and the protruding portions corresponding to each one of the discharge cells have the second gap in between, and
wherein the second gap is smaller than the first gap.

17. The plasma display panel of claim 16,
wherein the discharge cells are polygonal in cross section and the first electrodes and the second electrodes are polygonal rings, and
wherein the protruding portions are cylindrical bars.

18. The plasma display panel of claim 16,
wherein the discharge cells are cylindrical and the first electrodes and the second electrodes are circular rings, and
wherein the protruding portions are cylindrical bars.

19. A method for driving a plasma display panel having a front substrate and a rear substrate, discharge cells formed within a space between the front substrate and the rear substrate, first and second display electrodes corresponding to each discharge cell formed in pairs surrounding a corresponding discharge cell, the first and second display electrodes within a pair having a first gap in between, and address electrodes including portions projecting inside each of the discharge cells and located at a second gap from the first and second display electrodes, the first gap being measured along a direction substantially parallel to walls surrounding the discharge cells and substantially perpendicular to the rear substrate, the second gap being measured along a direction substantially parallel to the rear substrate, the method comprising:
applying a first voltage having a first pulse to one of the first and second display electrodes;
applying a second voltage having a second pulse to the other one of the first and second display electrodes, the second pulse being equal to the first pulse in amplitude and duration and being delayed with respect to the first pulse not to overlap the first pulse; and
applying a third voltage having a third pulse to the address electrodes, the third pulse having an amplitude and a duration both smaller than the second pulse, the third pulse repeating to coincide with each occurrence of the first pulse and each occurrence of the second pulse.

20. The method of claim 19,
wherein a voltage difference between the address electrodes and one of the first and second display electrodes across the second gap triggers a discharge in the discharge cells, and
wherein a voltage difference between the first and second display electrodes across the first gap sustains the discharge in the discharge cells.
